(19) United States
(12) Patent Application Publication
(10) Pub. No.: US 2009/0125554 A1
(43) Pub. Date: May 14, 2009

(54) STATISTICAL PROCESS CONTROL RESOURCE TRACKER

(76) Inventor: George E. Orient, Northridge, CA (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/939,868

(22) Filed: Nov. 14, 2007

(51) Int. Cl. G06F 7/00

(52) U.S. Cl. 707/104.1; 707/E17.045

(57) ABSTRACT

A method of monitoring performance data from at least one resource configures at least one resource to automatically transmit performance data, and registers the at least one resource in a relational database. Performance data is collected from the at least one resource, and is stored in the database. An actor provides input, and performance data is reported to the actor in response to the input.

### BACKGROUND OF THE INVENTION

This application relates to statistical process control, and more particularly to a method of monitoring statistical process control performance data from at least one resource.

Statistical process control (“SPC”) is a system involving the use of statistical techniques to measure and analyze variations in a process. SPC is typically used in manufacturing processes to monitor product quality and to monitor health of machinery. For example, a given manufacturing process may involve a number of steps performed by a machine. SPC can be used to measure a performance of the machine to track a number of successful steps and a number of failed steps performed by the machine. This information can be compared to an expected performance of the machine to monitor the health of the machine and to improve performance of the manufacturing process. However, tracking performance data may involve a human manually entering data at a terminal. It is desirable to automate a given resource so that human interaction is not required.

In addition, there are many additional resources which could benefit from SPC improvements, such as websites, computer applications, spreadsheets, and finite element models. Accordingly, it is desirable to provide an efficient and effective method of monitoring performance data from at lease one resource.

### SUMMARY OF THE INVENTION

A method of monitoring performance data from at least one resource configures at least one resource to automatically transmit performance data, and registers the at least one resource in a relational database. Performance data is collected from the at least one resource, and is stored in the database. An actor provides input, and performance data is reported to the actor in response to the input. The present invention therefore provides an efficient and effective method of monitoring performance data from at least one resource.

These and other features of the present invention can be best understood from the following specification and drawings, the following of which is a brief description.

### BRIEF DESCRIPTION OF THE DRAWINGS

FIG. 1 illustrates an example system for monitoring performance data from a plurality of resources.

FIG. 2 illustrates a plurality of example steps for monitoring performance data from at least one resource.

FIG. 3 illustrates an example authentication screen.

FIG. 4 illustrates an example resource list.

FIG. 5a illustrates a first example report.

FIG. 5b illustrates a second example report.

FIG. 5c illustrates a third example report.

FIG. 5d illustrates a fourth example report.

FIG. 5e illustrates a fifth example report.

FIG. 6 illustrates example options for a report selection.

FIG. 7 illustrates a first example run chart report.

FIG. 8 illustrates a second example run chart report.

FIG. 9 illustrates an example architecture for the system of FIG. 1.

FIG. 10 illustrates an example data model for the system of FIG. 1.

### DETAILED DESCRIPTION OF THE PREFERRED EMBODIMENT

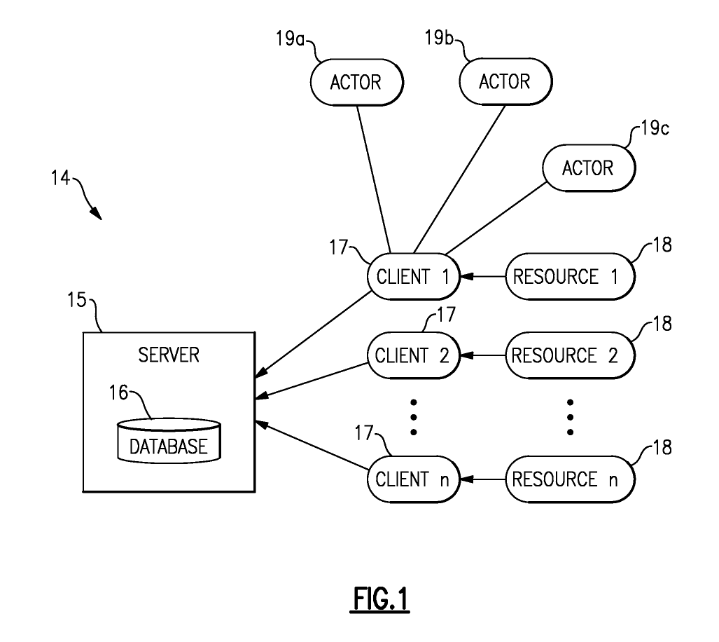

FIG. 1 schematically illustrates in block diagram form a statistical control (“SPC”) system 14 for monitoring performance data of a plurality of resources 18. A server 15 contains a relational database 16. The resources 18 are configured to automatically transmit performance data to the server 15 through a client 17. The server 15 stores the performance data in the database 16. While FIG. 1 shows each resource using a separate client, it is possible multiple resources 18 may use the same client. Some example clients include a command line client, a uniform resource locator (“URL”) client, and a web services client. A client may be a standalone program, such as a command line client, or it may be integrated into a resource, such as a software resource.

A type of client selected to automatically transmit data may depend on the server 15 and a configuration of a network connecting the server 15 to the resources 18. For example, if a resource and the server 15 are located within the same local area network (LAN), then the resource may be able to invoke a command line client to communicate with the database 16. If the server 15 is a web server, a resource may use a URL client by invoking a URL of the server to transmit performance data to the server 15, or a resource may invoke a web application on the web server. If the server 15 is a web service server, then a resource may invoke a web service client to transmit performance data to the server 15.

An actor 19 or a plurality of actors 19a, 19b, 19c may access the server 15 via a client 17 to obtain a report of performance data stored in the database 16. In one example, an actor 19 is a person, and in another example an actor 19 is a software program. Based on the reported data, the actor 19 may identify a failure or plurality of failures that occur most frequently in the performance data, and may then alter the resources 18 to improve performance.

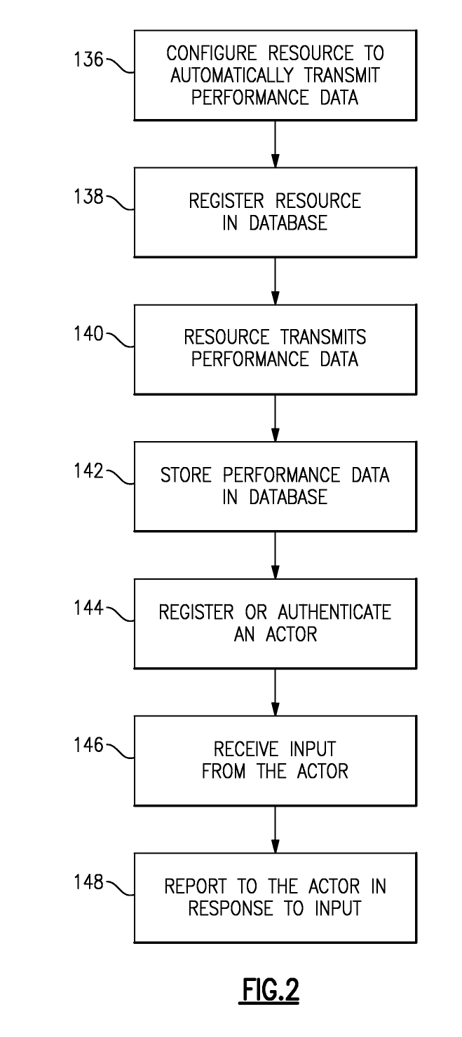

FIG. 2 illustrates a plurality of example steps for using the SPC system 14. In a first step 136, at least one resource is configured to automatically transmit performance data using a client. As mentioned above, some example clients include a command line client, a uniform resource locator (“URL”) client, and a web services client.

In a second step 138, the at least one resource is registered in the database 16 on the server 15. In an example simplified registration, only a name and version of the at least one resource is registered. In this simplified registration, the at least one resource has a single state and the resource performance data only indicates if the resource is accessed. In an example detailed registration, category, version, actor, and state information for multiple states are registered for the at least one resource.

In a third step 140, at least one resource 18 transmits performance data to the server 15. Because the at least one resource automatically transmits performance data through a client, the server 15 simply receives a transmission or plurality of transmissions of performance data from a client associated with the at least one resource.

In a fourth step 142 the performance data is stored in the database 16 as a data log entry or a plurality of data log entries. An example log entry could include a resource ID, a resource state, an instance ID, and business metadata. An example instance ID could include a user name and a message, and example business metadata could include a business unit, a technology area, a project name, or a program associated with the at least one resource.

In a fifth step 144 an actor is registered or authenticated. As mentioned above, an actor may be either a person or a software program. In the example of a new user, the new user could be registered in step 144. In the example of an existing user, the existing user could be authenticated in step 144 by verifying if a username and password entered by the user match a corresponding username and password stored in the database. In the example of a software program actor, the software program could be authenticated in step 144 to verify that the program should be granted access to performance data in the database 16.

In a sixth step 146 an actor provides input. In one example, actor input may include a selection of at least one resource, a report selection, and a report parameter selection. In a seventh step 148, a report is provided to the actor based upon the input from step 146.

The SPC system 14 is flexible, and can receive performance data from a wide variety of resources, such as spreadsheets, documents, web pages, computer controlled network devices, and any other item that is capable of electronically transmitting performance data. The SPC system 14 provides a unified system to collect performance data and to process, visualize, and report that data.

In one example, a resource 18 is a spreadsheet. In this example, a client may be embedded in either the spreadsheet or an associated spreadsheet program to provide performance data to the database 16. The performance data may include such states as spreadsheet access, spreadsheet modification, and spreadsheet formula execution.

In one example, a resource 18 is a web page that transmits data through a URL client. In this example, command line arguments may be included in a URL for the website, so that when an actor accesses the web site through a web browser, the web browser transmits performance data to the database 16. Alternatively, the client could be built into the web browser itself to transmit performance data without the need for command line arguments in a URL. The performance data may include such states as web site access, web site hyperlink selected, etc.

FIG. 3 illustrates an example authentication screen 20 for a SPC system where an actor may login, change a password, or register as a user. The screen has a field 21 for a username, and a field 22 for a password. The actor may enter a username and password in the fields 21, 22 and may then select a button 24 to login. The actor may also select a button 26 to change a password. An actor may also register as a new user by selecting a button 28.

FIG. 4 illustrates an example resource list for a SPC system that includes a plurality of registered resources 30a-f. However, it is understood that FIG. 4 is an example and that more or less resources may be included in a SPC system. An actor may make a selection 32 to choose one of the plurality of resources. In the example of FIG. 4, each resource has a realm 34, a realm version 36, a resource name 38, a resource version 40, and a resource description. The realm 34 is a descriptive category for a resource 18. An actor may select a button 44 to process a selected resource, a button 46 to delete a selected resource, or a button 48 to add a new resource. While the example of FIG. 4 illustrates a selection 32 that is a radio button field, it is understood that it would be possible to have another selection field, such as a checkbox, wherein multiple resources could be simultaneously selected.

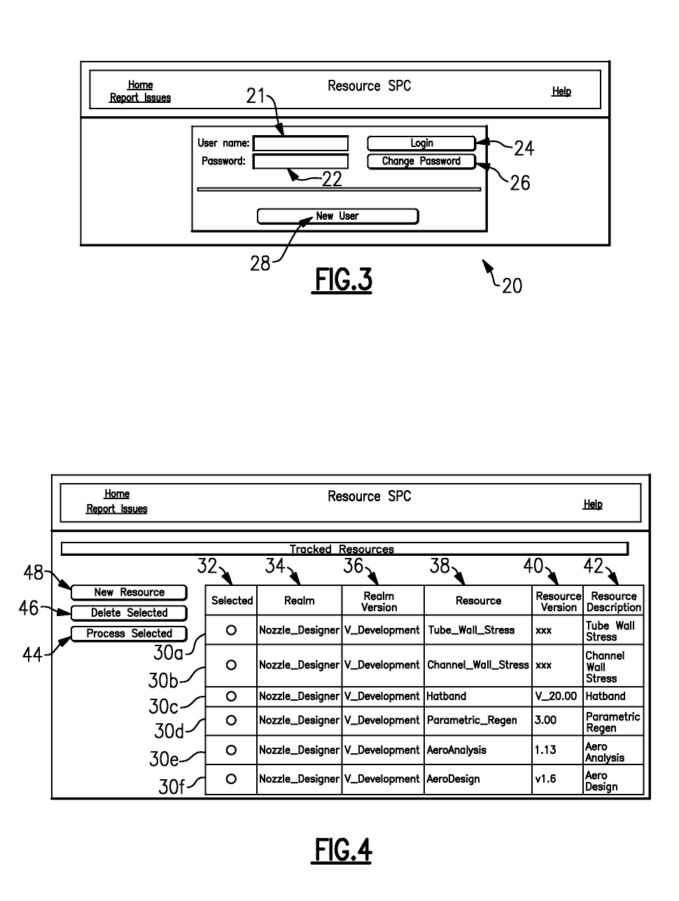

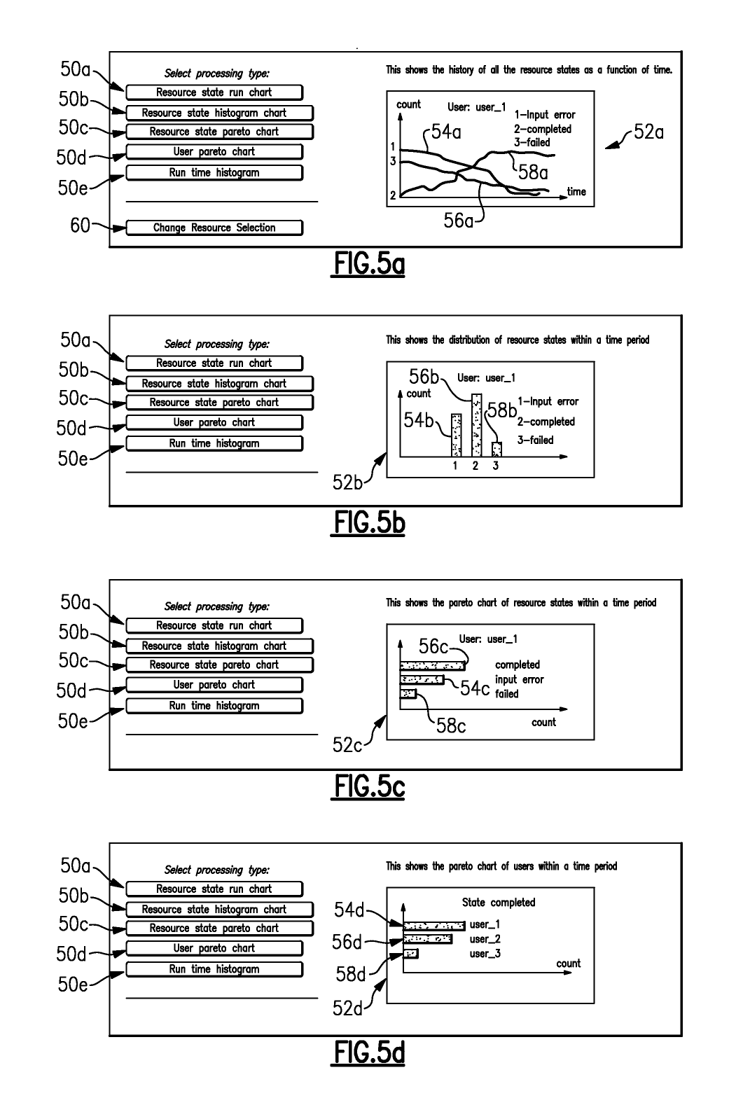

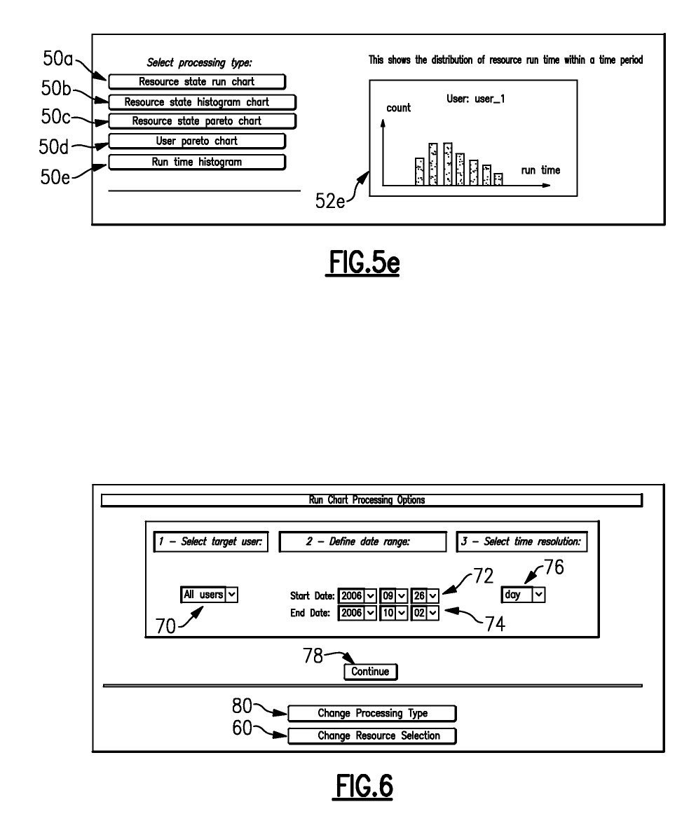

FIGS. 5a-e illustrate a plurality of example reports 52a-e corresponding to a plurality of buttons 50a-e. In one example, when a user places a cursor over one of the buttons 50a-e, a corresponding example report 52a-e is shown. A user may also select a button 60 to select another resource. Once a user selects one of the buttons 50a-e to make a report selection, a report associated with the button 50a-e may be generated using actual performance data. Before the report is displayed, a user may first be prompted to input report parameters to accompany the resource and report selection.

FIG. 5a illustrates an example resource state run chart 52a corresponding to button 50a. The state run chart 52a illustrates a quantity of input errors 54a, successful completions 56a, and failures 58a for an example resource as a function of time.

FIG. 5b illustrates an example resource state histogram chart 52b corresponding to button 50b. The state histogram chart 52b illustrates a quantity of input errors 54b, successful completions 56b, and failures 58b for an example resource within a time period.

FIG. 5c illustrates an example resource state pareto chart 52c corresponding to button 50c. The state pareto chart 52c illustrates a quantity of input errors 54c, successful completions 56c, and failures 58c for an example resource within a time period.

FIG. 5d illustrates an example user pareto chart 52d corresponding to button 50d. The user pareto chart 52d illustrates a quantity of successful completions 54d, 56d, and 58d corresponding to example users 1, 2, and 3 respectively.

FIG. 5e illustrates an example run time histogram chart 52e corresponding to button 50e. The run time histogram chart 52e illustrates a distribution of resource run time for an example user within a time period.

FIG. 6 illustrates a plurality of parameters that may be used in selecting data for generating a chart. In one example, FIG. 6 is shown to an actor after the actor selects one of the buttons 50a-e. In a field 70, a user or a plurality of users to include in the report data may be selected. An actor may select a range of dates to include in a report using fields 72 and 74. In a field 76, an actor may select a time period within the data range. An actor may then select a button 78 to continue, a button 80 to change a report selection, or the button 60 to select a new resource.

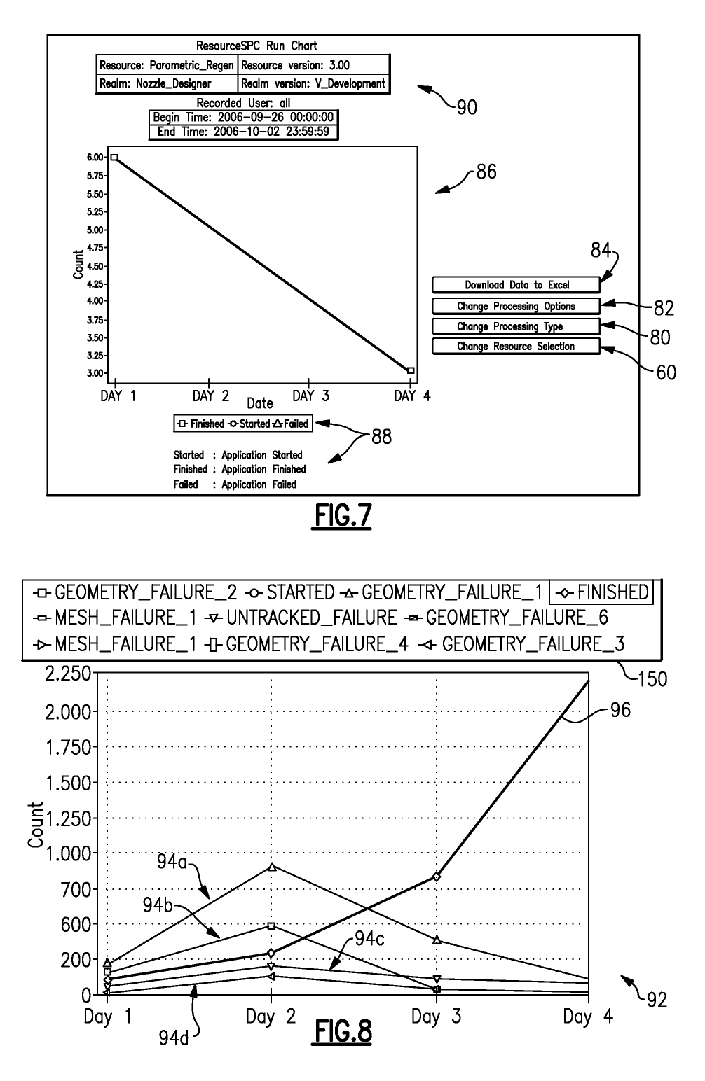

FIG. 7 illustrates a first example run chart 86. A legend 88 describes the example data in the chart 86. This example includes data 90 about a resource and a time span included in the chart 86. This example indicates six successful application completions on day 1, and three successful application completions on day 4. A user may select a button 82 to change report parameters, as shown in FIG. 6, or may select a button 84 to download data from the chart 86 to a database program, such as Microsoft® Excel. A user may also select the button 60 to select a new resource, or the button 80 to change a report selection.

The SPC system 14 of the present invention is applicable to complex engineering problems, including finite element analysis (“FEA”). In an engineering application, a finite element model (“FEM”) may have multiple failure modes, and may have hundreds of occurrences of each failure mode. In such a case, it is useful to address the most frequently occurring failure modes. The SPC system 14 may be used to make this determination.

FIG. 8 illustrates a second example run chart 92 including FEM data. A legend 150 describes the example data in the chart 92. The chart 92 indicates a number of occurrences of a plurality of failures 94a-d and a number of successful completions 96. The chart 92 identifies that at day 2, the quantity of failures 94a-d was greater than the quantity of successful completions 96. One could use this data to troubleshoot the failures 94a-d to improve a performance of a system. The chart 92 further identifies that at day 4 the quantity of successful finishes 96 was greater than the quantity of failures 94a-d.

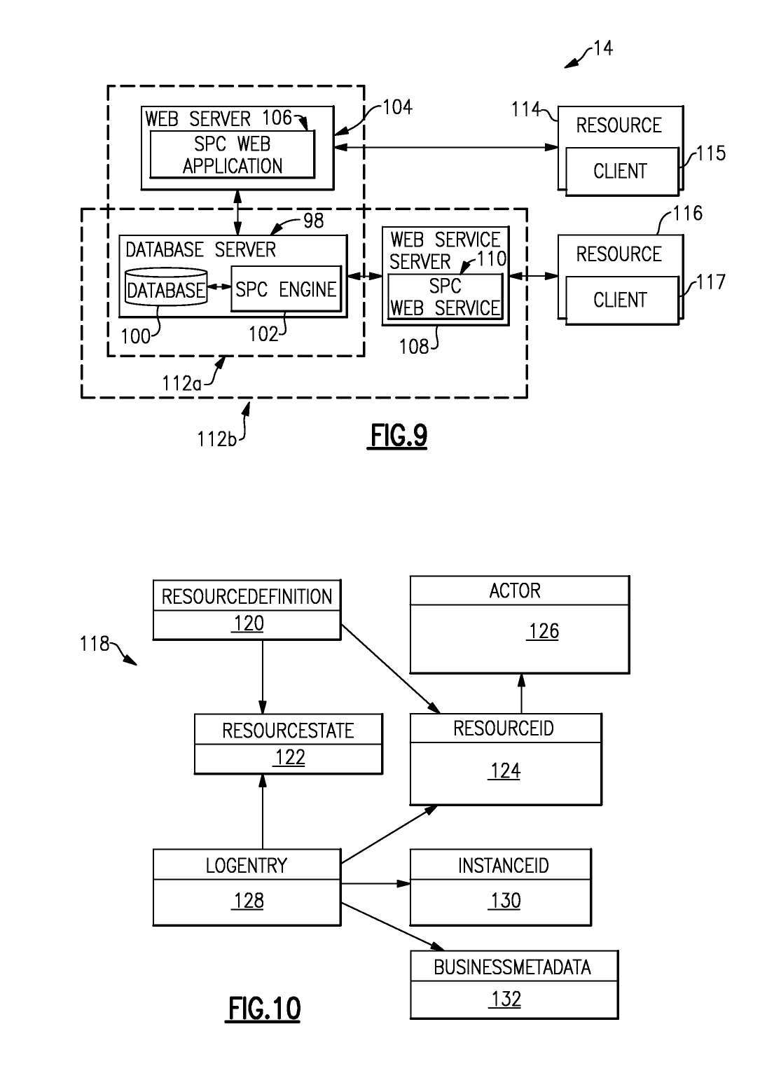

FIG. 9 illustrates an example architecture for a SPC system. However, it is understood that the architecture in FIG. 9 is only an example, and that other architectures could be used to implement the SPC system 14. A database server 98 contains a database 100 and an SPC engine 102. In the example of FIG. 9, the SPC engine is a program on the database server 98 that interacts with the database 100 to store and retrieve information. A web server 104 contains a web application 106. A web service server 108 contains a web service 110. While the example of FIG. 8 illustrates both a web server 104 and a web service server 108, it is understood that only one of a web server 104 or a web service server 108 would be necessary for the system 14. A firewall 112a isolates the database server 98 and the web server 106 from resources 114, 116 and clients 115, 117. A firewall 112b isolates the database server 98 from the web service server 108 from resources 114, 116 and clients 115, 117. Because only one of a web server 104 or a web service server 108 is necessary for the system 14, it is understood that only one of a firewall 112a or a firewall 112b would be necessary. The SPC engine 102 receives requests from the web server 104 and the web service server 108 and retrieves data from the database and transmits that data to the web server 104 and web service server 108. In one example, the system 14 is implemented using open source software, including a MySQL® database, a Tomcat web server, and a Java Web Services Developer Pack (“JWSDP”).

FIG. 10 illustrates an example data model 118 for the SPC system 14. However, it is understood that the data model 118 is only an example, and that other data models could be used to implement the SPC system 14. A resource definition 120 comprises a resource ID 124 and at least one resource state 122. A resource state 122 could include a name and a description of the resource state. A resource ID 124 could include a resource name, a resource category, a resource version, a resource description, and at least one actor 126 eligible to access data for the resource. An actor 126 could include a user name, and a privilege for a user, such as if a user is able to view performance data, or is able to view and edit performance data.

A log entry 128 is a portion of performance data. A log entry 128 could include a resource ID 120, a resource state 122, an instance ID 130, and business metadata 132. An instance ID 130 could include a user name and a message, and business metadata 132 could include a business unit, a technology area, a project name, or a program.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of monitoring performance data from at least one resource, comprising:
(A) configuring at least one resource to automatically transmit performance data;
(B) registering the at least one resource in a relational database;
(C) collecting performance data from said steps (A), (B);
(D) storing the performance data in the relational database;
(E) receiving input from an actor; and
(F) reporting to the actor in response to said step (E).

2. The method of claim 1, wherein said step (A) includes configuring the at least one resource to invoke a client to automatically transmit performance data.

3. The method of claim 2, wherein said step (C) includes receiving performance data from the client.

4. The method of claim 1, wherein said step (B) includes:
providing a resource name;
providing a resource version;
providing a resource category; and
providing at least one resource state.

5. The method of claim 1, wherein said step (E) includes:
(a) authenticating an actor;
(b) providing a list of available resources and a list of available reports to the actor; and
(c) receiving a resource selection and a report selection from the actor.

6. The method of claim 5, wherein said step (a) includes checking if a username and password entered by the user match a corresponding username and password stored in the database.

7. The method of claim 5, wherein said step (c) includes a selection of a plurality of resources.

8. A system for monitoring performance data from at least one resource, comprising:
at least one resource configured to automatically transmit performance data;
a relational database, wherein the at least one resource is registered in the database; and
a server operable to receive performance data from the at least one resource, to store performance data in the database, and to provide a report of performance data based on input from an actor.

9. The system of claim 8, further comprising a client associated with the at least one resource, wherein the at least one resource is configured to automatically transmit performance data by invoking the client.

10. The system of claim 8, wherein said input includes a selection of at least one resource selected from a list of available resources.

11. The system of claim 8, wherein said input includes a report selected from a list of available reports and at least one report parameter selected from a list of available report parameters.

12. The system of claim 8, wherein the actor is authenticated by checking if a username and a password entered by the actor match a corresponding username and password stored in the database.

13. The system of claim 8, wherein each of the plurality of resources registered in the database has a resource name, a resource version, a resource category, and at least one resource state.

14. The system of claim 8, wherein at least one of said plurality of resources is a finite element model.

15. The system of claim 8, wherein at least one of said plurality of resources is a software program.

16. The system of claim 8, wherein at least one of said plurality of resources is a website.

17. The system of claim 9, wherein the client is a command line client.

18. The system of claim 9, wherein the client is a uniform resource locator client.

19. The system of claim 9, wherein the client is a web service client.

20. A computer-implemented method of monitoring performance data from at least one resource, comprising:
(A) registering at least one resource in a relational database;
(B) receiving automatic transmissions of performance data from the at least one resource;
(C) storing the performance data in the relational database;
(D) receiving input from an actor; and
(E) reporting to the actor in response to said step (D).
